(19) United States
(12) Patent Application Publication
(10) Pub. No.: US 2005/0014483 A1
(43) Pub. Date: Jan. 20, 2005

(54) Event based charging for mobile applications

(76) Inventor: Lars Lagerstrom, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/683,462

(22) Filed: Oct. 14, 2003

(30) Foreign Application Priority Data
Jul. 17, 2003 (GB) 0316743.4

(51) Int. Cl. H04M 11/00

(52) U.S. Cl. 455/405; 455/426.1

(57) ABSTRACT

A method of charging for use of a mobile application includes identifying a trigger associated with a chargeable event, identifying a user requesting such event, and providing details of the chargeable event and the user to a charging function.

### BACKGROUND OF THE INVENTION

1. Field of the Invention

The present invention relates to techniques of charging for use of mobile applications, and particularly but not exclusively to the use of applications such as games from mobile terminals via a mobile telecommunications network.

2. Description of the Related Art

As mobile terminals become more advanced, there is a growing number of applications provided which run at least partly in the mobile terminals themselves. These applications, which may be referred to as mobile applications, can be either stand-alone or interactive. Interactive applications can be further divided into client-server interactive applications and client-client interactive applications.

Network operators need to implement charging of applications used on mobile terminals which require at least some access with the mobile telecommunications network.

The charging functionality currently implemented in current service platforms is not ideal. Existing charging is primarily based on volume of data traffic. As such, costs associated with usage of an application or service are unpredictable to the end-user. Existing charging structures do not provide satisfactory support for prepaid users. For prepaid users, the volume of data traffic may be such that insufficient credit exists in order to use a particular application. However this only may become apparent after the attempt to use or access an application has begun.

Usage of a service associated with an application from a mobile terminal may be considered to be an ‘event’. An alternative to charging based on data volume for network operators is to implement event based service pricing. This would allow access to a service to be a fixed price. This is desirable as it makes service pricing understandable and transparent to an end user, and better reflects the perceived value of the service to the end user.

Client-server applications are currently the main type of interactive application. Client-client applications may become more prevalent when session initiation protocol (SIP) becomes more generally available in mobile networks.

Stand-alone applications are typically embedded in the terminal, or downloaded in a single session. They are not associated with the operator's charging infrastructure, and consequently the network operator has no means for innovative charging alternatives, for example charging based on usage or events, other than when a user makes a network access, for example, to download or upgrade a stand-alone application.

Innovative charging (for example event based charging) for client-server applications can in theory be accomplished by integrating the server part of the application with the operator's charging infrastructure. However, the integration of new service platforms with the network operator's charging infrastructure is challenging due to the necessary investment involved. This is especially true for service platforms residing outside of the network operator premises. Different service platforms are based on different proprietary implementations, and thus no standard exists. This makes the integration of such platforms to the network operator's charging infrastructure difficult and costly. A dedicated interface may be required for each service platform.

In addition, the mobile terminal identity, MSISDN, is usually not sent to the service platform external to the network operator, and as such this makes tracking of charging difficult.

In view of the above drawbacks, operators principally continue to use basic charging models, which are based on data volumes. This has a negative effect on service usage since the charges associated with a particular application are not readily apparent to a user.

It is an aim of the present invention to provide an improved technique for charging for mobile applications.

### SUMMARY OF THE INVENTION

According to one aspect of the present invention there is provided a method of charging for use of or access to a mobile application. The method preferably includes identifying a trigger associated with a chargeable event, identifying a user requesting such event, and providing details of the chargeable event and the user to a charging function.

The trigger may include an event identifier and a user identifier, where the identifiers form the details of the chargeable event. The event identifier may be, for example, a URL. The user identifier may be, for example, a MSISDN. The trigger may also be a request from a user terminal to an application. The trigger may also be a response from an application to a request from a user terminal.

In one embodiment, the application is provided by an application server and the request or the response may be a HTTP Message.

In another embodiment, the application is provided by an application client and the request or the response may be a SIP Message. The trigger may be contained in the header of a message. The response may include an authorization of the request and the application may provide authentication.

According to another aspect of the present invention there is provided a network element for enabling charging for a mobile application, the network element including a mechanism to identify a trigger associated with a chargeable event; a mechanism to identify a user requesting such event; and a mechanism to provide details of the chargeable event and the user to a charging function.

The mechanism to identify the trigger includes a unit to identify an event identifier and a user identifier, said identifiers forming the details of the chargeable event. The event identifier may be a URL and the user identifier may be a MSISDN.

The mechanism to identify the trigger may be adapted to identify a request from a user terminal to an application. The mechanism to identify the trigger may be adapted to identify a response from an application to a request from a user terminal.

The application may be provided by an application server and the request or the response may be a HTTP Message.

The application may also be provided by an application client and/or the request or the response may be a SIP Message.

In one embodiment, the network element may be a traffic analyzer and further adapted to identify the trigger in a header of a message.

The network element may also be a GGSN (Gateway GPRS Support Node). A mobile communications system may include the network element.

According to a further aspect of the invention there is provided a method of charging for a mobile application, including generating a trigger identifying a chargeable event and a user associated with the request for such an event, and providing details of the chargeable event and the user to a charging function. The step of providing details to the charging function may include transmitting the trigger to a mobile communications network.

The trigger is preferably generated responsive to use of the mobile application and the mobile application is preferably a stand-alone application. The trigger may be a request to an application server and/or is a request to a mobile terminal.

The method may further include creating a message containing the trigger in a header thereof.

The invention preferably provides a program adapted to perform the method and the mobile application preferably includes the program. A computer program product may contain computer program code for performing the method.

In a still further aspect, the present invention provides a mobile terminal adapted for charging of a mobile application, including a component for generating a trigger identifying a chargeable event and a user associated with the request for such an event, and a component for providing details of the chargeable event and the user to a charging function.

The component for providing details to the charging function may include a transmitter for transmitting the details to a mobile communications network incorporating a charging function.

### BRIEF DESCRIPTION OF THE DRAWINGS

The present invention is now described with regard to a particular example with reference to the accompanying drawings in which:

FIG. 1 illustrates an overview of a network architecture illustrating the principles of operation of the present invention;

FIG. 2 illustrates the method steps in an example implementation of the present invention utilizing a preferred embodiment; and

FIG. 3 illustrates a charging table for implementation in accordance with a preferred embodiment of the invention.

### DETAILED DESCRIPTION OF THE PREFERRED EMBODIMENTS

The present invention is described herein by way of reference to a particular example implementation. The invention is not, however, limited to such an implementation. Various modifications and adaptations to the described implementation would be apparent to one skilled in the art reading the following description.

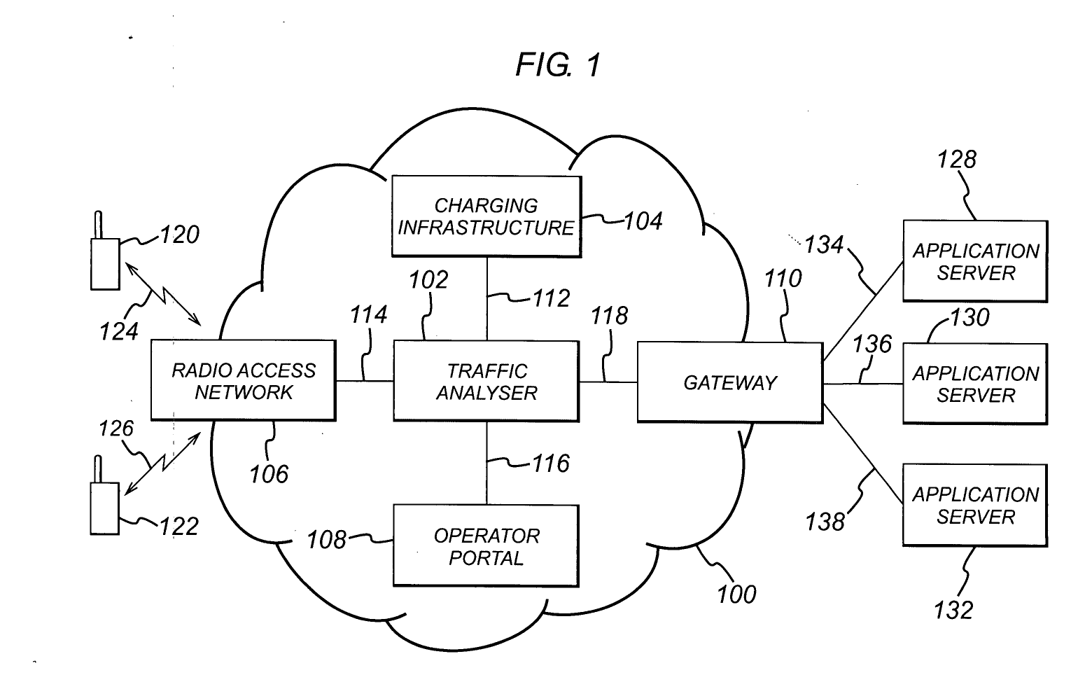

Referring to FIG. 1, there is illustrated an example communication network architecture in which the present invention may be advantageously implemented.

An operator network 100 includes a radio access network 106, a charging infrastructure 104, an operator portal 108, a traffic analyzer 102, and a gateway 110. It would be understood by one skilled in the art that further functionality may be required to implement a mobile communications network. However such functionality is known in the art, and only sufficient detail of the operator network 100 is illustrated in FIG. 1 to understand the present invention. In particular, the gateway 110 may in practice be a GGSN (gateway GPRS support node).

Also shown in FIG. 1 are two mobile terminals, or user equipment, 120, 122. In addition a plurality of applications servers 128, 130 and 132 are illustrated. The application servers 128, 130, 132 are external to the operator network 100.

As is well-known in the art, the mobile terminals 120 and 122 communicate with the radio access network 106 via wireless links 124 and 126 respectively. In such a way, the mobile terminals 120 and 122 connect into the operator network 100 via the radio access network 106.

Communications may be established between the mobile terminals 120 and 122, via the operator network 100, to external application servers 128, 130 and 132. The details for establishment of communication links between the mobile terminals 120, 122 and the application servers 128, 130, 132 is not significant, and is not further described herein.

Referring further to FIG. 1, it is shown that the radio access network 106 is connected to the traffic analyzer 102 via a communication link 114. In addition the traffic analyzer 102 is connected to the charging infrastructure 104 via communication link 112, the operator portal 108 via communication link 116, and the gateway 110 via communication link 118. However, it is also possible that certain components in network 100 may be integrated with another and respective lines accordingly omitted.

All traffic to and from the mobile terminals 120, 122 via the radio access network 106 passes through the traffic analyzer 102, such that the traffic analyzer can analyze the traffic in accordance with known techniques. The traffic analyzer 102 interfaces with the charging infrastructure 104 in order to charge for the mobile terminals use of the operator network in accordance with known techniques.

The traffic analyzer 102 additionally may direct traffic to the operator portal 108 via communication link 116. For example, if an application accessed by the user terminals 120 or 122 is not an external application but an application provided by the network operator, then the traffic associated with any request is directed to the operator portal 108. Even if the application is an external application, in order for the network operator to have control over charging, the charging URL may be an operator portal. Such arrangements are known in the art. Similarly, any application data returned or downloaded to the mobile terminals 120, 122 is provided from the operator portal 108 to the radio access network 106 via the traffic analyzer 102.

The traffic analyzer 102, in addition, is connected to the gateway 110 such that the traffic associated with external applications may be directed to such external applications via the gateway 110. Similarly, data from the application servers directed to the mobile terminals 120, 122 is directed through the gateway 110.

In accordance with one embodiment of the present invention, the network operator in control of the operator network 100 can charge for certain events associated with a mobile application. Such event may be the start of an application, the use of a special feature within the application, the enabling of a chargeable option associated with the application, etc. For example, where the application is a game, the event may be selection of an option (e.g., a start game option), an option to select a new game level, an option to select a new weapon for a game, an option to select a new game scenario (e.g. a new race track), etc.

The invention enables an application running in a mobile terminal to generate charging events, which are detected by the traffic analyzer 102 in the mobile network. The connection of the traffic analyzer 102 to the charging infrastructure 104 enables initiation of charging in dependence on an event. The charging may be prepaid or post-paid. The charging requires no interface of the charging infrastructure of the network to any external applications.

When the user of a mobile application requests a service or access associated with an application, which is charged by the network operator, a charging event is generated. Preferably, the charging event is generated in dependence upon an identifier in the protocol header of a message which passes through the traffic analyzer 102. The charging event is preferably based on the header information, so that the payload of the message can be used for any necessary information to be transferred end-to-end, or alternatively left empty. Advantageously, there is no requirement for the traffic analyzer to process the payload of a message. The traffic analyzer 102 is able to detect the message, and the event identified in the header, based on the user protocol and the identifier in the protocol header.

In a preferred embodiment, the charging infrastructure 104 includes a functionality to map a particular protocol header identifier to a tariff or other charging data, which can determine the actual amount to be charged.

In a further preferred embodiment, the event charging is triggered by a response message to the mobile terminal detected by the traffic analyzer 102.

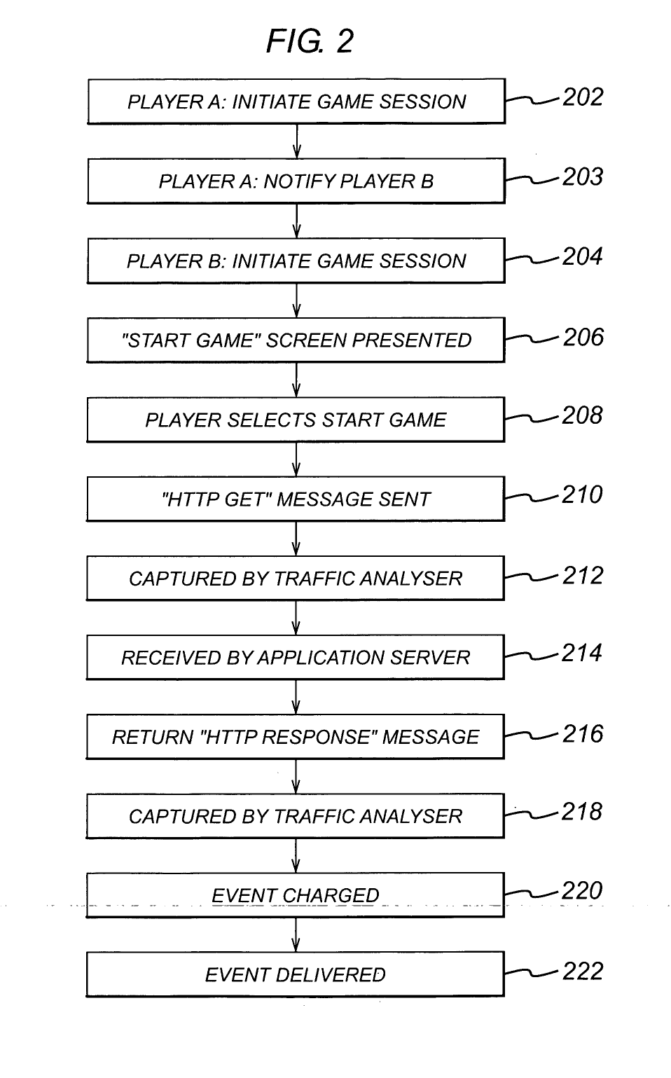

The general principles of operation of the present invention can be illustrated with reference to a simple example illustrated by the flow chart of FIG. 2 and with further reference to FIG. 1.

In FIG. 2, an example is given where two players, player A and player B, each associated with the mobile terminals 120 and 122 respectively, initiate a game session associated with the application server 128. Preferably player A initiates the game session, and invites player B to join in an interactive game session.

In step 202, player A initiates the game session from the mobile terminal 120 to the application server 128 in accordance with known techniques. A communication session is established between the mobile terminal 120 and the application server 128 via the mobile network 100 using known techniques.

As part of the initiation of the game session, the player A using terminal 120 may be provided with the price of the game session from the application server 128, and player A accepts the price. The establishment of a session in this way is known in the art.

For an interactive session, in step 203 player A notifies player B, associated with mobile terminal 122, of the identity of the session so that player B can join in an interactive game session with player A.

In step 204, the initiation of the game session in step 202 is repeated for player B using mobile terminal 122. In initiation, the session associated with player A is identified.

After each of the players initiates the game session, and obtains and accepts the price associated with the game session, at step 206, each player is presented with a “start game” screen on their respective mobile terminals 120 and 122.

In step 208, each player selects the “start game” option on the screen of the mobile terminal 120 or 122. As a result, a “HTTP GET” message is sent from each mobile terminal 120, 122 to the operator network 100. The “HTTP GET” message includes the terminal MSISDN, and a unique URL associated with the event, which corresponds to a charging price. The URL can thus be termed a “charging URL.” In this example the charging URL corresponds to a “start game” event

This message is captured by the traffic analyzer 102. As is discussed further hereinbelow, responsive to receipt of this message the traffic analyzer does not, in a preferred embodiment, initiate any charging in accordance with the present invention. However, in alternative embodiments the charging initiation described hereinbelow may be initiated at this point.

In step 214 the “HTTP GET” message is sent from the traffic analyzer to the application server 128 via the gateway 110. The application server, as part of the processing of such message, authenticates the request associated with the mobile terminal 120 or 122.

After successful processing of the message, which may include authentication of the user, in step 216 the application server 128 returns a “HTTP RESPONSE” message to each mobile terminal.

At step 218, each response message is captured by the traffic analyzer 102. On capturing the message, the traffic analyzer extracts the charging URL and the MSISDN of the mobile terminal contained in the header of the response message. The charging URL and the MSISDN are then forwarded to the charging infrastructure 104. In step 220 the event, i.e. the game-start event, is charged to the player associated with that MSISDN. In step 222 the event is delivered (e.g., the game is started) to the user.

It should be noted that although in the described embodiment the MSISDN is extracted from the header of the message and used to identify a user for charging, the invention is not limited to such an arrangement. In general, it is desired to identify the user (e.g. client or subscriber) associated with the request, and provide this to the charging function. This may be achieved by extracting the MSISDN, by extracting the IP address from which the request originated, or from any other suitable information associated with the message which identifies the account to be charged.

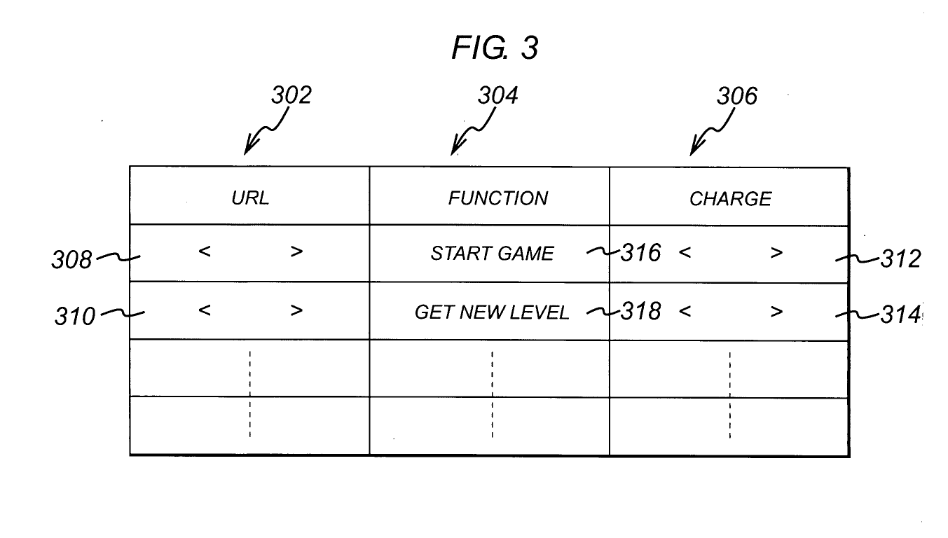

Referring to FIG. 3, in a preferred embodiment each URL is associated with a unique event or function, and a charge is associated with such an event or function. As such, the charging infrastructure 104 may include a table, as shown in FIG. 3, having a column 302 listing all the chargeable URL's, a column 304 (optional) listing the event or function associated with each URL, and a column 306 listing a charge code or amount associated with such URL. As shown in FIG. 3, for URL 308, the associated event or function 316 is “start game”, and the associated charge is included in entry 312. A further URL 310 may be associated with the function 318 “get new level”, i.e. access a new level of the game, and be associated with a charge 314.

The transmission of the “HTTP GET” messages and “HTTP RESPONSE” messages associated with each of the terminals, such as terminals 120 and 122, associated with the interactive game session may be simultaneous or in sequence, depending on the network implementation and the application implementation.

As described above, the charging is preferably initiated based on detection by the traffic analyzer 102 of a “HTTP RESPONSE” message to the mobile terminal. Such a charging initiation may be utilized where the mobile application cannot be trusted, and where the authentication of the mobile terminal by the application server is desirable. A principle of the present invention is that a successful response can be detected, independent of the specific authentication technique utilized.

However, if the mobile application can be trusted, the traffic analyzer 102 may be adapted to instruct initiation of charging to the charging infrastructure 104 after it has captured a “HTTP GET” message sent to the application server 128 from the mobile terminal 120.

It is envisioned that in current applications the authentication of the session prior to initiation of charging is essential, and that therefore current implementation will trigger charging based on the response message from the application server. The payload of the message has a session identifier, which is in essence a password, which is used by the application server 128 to authenticate the application associated with the mobile terminal 120, 122. As the traffic analyzer 102 does not analyze the payload, this session identifier is not used by the traffic analyzer. Thus, in the preferred embodiments, the “HTTP response” returned by the application server 128 responsive to a successful verification, and the appropriate successful status code in the header, is used by the traffic analyzer 102 in order to determine whether charging should be initiated.

The “HTTP RESPONSE” message sent by the application server 128 preferably includes a status code in the header, which in the preferred embodiment using HTTP, is either a status code indicating a successful request (e.g. “200)), or a status code indicating “NOT OK” (e.g., “403”). This status code is preferably used by the traffic analyzer 102 to determine whether charging should be initiated.

It is envisioned in the current applications that initiation of charging initiated only on the sending of a message would not be appropriate because the message could be sent by any party. As such authentication is important. However, in a trusted environment, initiation of charging on sending a message is possible. Thus the invention is not limited to a requirement for authentication, or for charging to be based only on a response message.

As discussed hereinabove, in the preferred embodiments, each charging event will be associated with a unique URL, or charging URL. As such the charging infrastructure 104 merely needs to receive this URL, together with an identity of the user, for an event can be charged to the correct account. In further modifications of the invention, however, the information passed by the traffic analyzer to the charging infrastructure 104 may be more sophisticated. This is particularly likely to be the case where a large number of events are possible. Where large numbers of events become possible, and large numbers of applications are available, each having large number of events associated therewith, the provision of a unique URL for each charging event may no longer be practical. As such additional identifiers may be used by to the charging infrastructure 104 in order to enable charging.

In the above described example, the application resides in an application server external to the operator network. The principles of the present invention apply equally to an application which is accessible via the operator portal 108 of the operator network. The use of a URL in order to initiate charging can be used in the same way as described hereinabove. All traffic between a mobile terminal and the operator portal similarly passes through the traffic analyzer.

The example described hereinabove with relation to FIG. 2 relates to a client-server application. However, the principles of the present invention may similarly be used in relation to a client-client application. Client-client applications are likely to be based on establishment of SIP sessions between two players via a network including a traffic analyzer such as the traffic analyzer 102. Thus the traffic analyzer 102 can be used in the same way as described hereinabove in relation to the client-server application in order to initiate event based charging.

The principles of the present invention may also be used in relation to stand-alone applications, as opposed to interactive applications. For example, if a user of a mobile terminal 102 downloads a stand-alone application from an application server or via the operator portal, the same principle of event based charging as described above may be applied. Similarly even for a stand-alone application, it may be possible to pay extra in order to obtain additional game features, such as access to a further level, which may be obtained by accessing the application server or the operator portal, and the principles for event charging described herein would apply similarly.

The invention described with relation to FIG. 2, is discussed in relation to a HTTP protocol. The invention is not limited to any particular protocol, and as also been mentioned hereinabove may be used with an SIP protocol or other protocol as suitably appropriate. The invention is particularly described herein with relation to a HTTP protocol in view of the current implementation of network elements equivalent to the traffic analyzer 102 being based on HTTP implementations.

The traffic analyzer 102, however, may be any network element which provides the functionality of identifying headers contained in the packets of a data session. More generally, the traffic analyzer is required to be able to identify an event which is to be charged, and identify a client to which that event is to be charged, and provide associated identifiers to a charging mechanism. Network elements providing the functionality of the traffic analyzer 102 are known in the art, and are also known to provide functionality such as intelligent content delivery, and intelligent traffic analysis.

It should be noted that FIG. 1 is illustrative of an overview functionality of the invention, and an actual implementation in a known network environment will be familiar to one skilled in the art. For example, although the traffic analyzer 102 is illustrated as a distinct element, it could in practice be integrated in the gateway element 110. In one implementation, this gateway element may be a GGSN (gateway GPRS support node). It should also be noted that the traffic analyzer may not be connected directly to the operator portal 108 in a practical implementation. This connection is likely to be via the gateway, especially where the traffic analyzer is integrated in the gateway.

Various possibilities exist for an event which may trigger an event based charge. As described above, many possibilities exist within the realms of interactive gaming alone. For example, an event may be associated with the start of a game, accessing a higher level of a game, accessing a new character associated with a game, accessing a new weapon associated with a game, accessing a new scenario associated with a game (e.g. a new race track). Numerous charge-based events will be apparent to one skilled in the art and thus are not exhaustively described herein. In addition although it is described herein that charging is event based, a network operator may in addition have the option to further charge in accordance with data traffic volumes associated with a download which the event triggers.

Event based charging does not require an access to an application server or client application on another mobile terminal. A mobile terminal may be provided with a stand-alone application, but for which it is required to pay for any use thereof. Thus in response to use of the stand-alone application, an appropriate trigger is sent to the network to initiate charging.

As discussed hereinabove, the trigger may be a request or an acknowledgement of a request. The trigger is preferably associated with an identity of the user of the application. For stand-alone applications, the trigger may simply be a charging command comprising the charging URL, pre-programmed into the mobile application.

Reference is made herein to the user of an application being charged. For post-paid customers, the user may be considered to be a subscriber or client. For pre-paid customers the user may simply be a user associated with a fixed credit. The user identity may be directly associated with a terminal identity, as such allowing the terminal identity to be used for charging purposes.

The use of the event based charging described herein, without traffic volume based charging, provides users with predictability of charging. In particular, in relation to prepaid customers, certainty of charging is provided. A fixed fee is associated with an event, as opposed to an unpredictable fee associated with a volume of data traffic associated with an event.

The present invention has been described herein by way of example with reference to various preferred embodiments. The invention is not limited to any specific embodiment. The scope of the invention is defined by the appended claims.

1. A method of charging for a mobile application, the method comprising:
identifying a trigger associated with a chargeable event;
identifying a user requesting such event, and providing details of the chargeable event and the user to a charging function.

2. The method according to claim 1, wherein the trigger includes an event identifier and a user identifier, said identifiers forming the details of the chargeable event.

3. The method according to claim 2, wherein the event identifier is a Unified Resource Locator.

4. The method according to claim 2, wherein the user identifier is a Mobile Subscriber Integrated Services Digital Network number.

5. The method according to claim 1, wherein the trigger is a request from a user terminal to an application.

6. The method according to claim 1, wherein the trigger is a response from an application to a request from a user terminal.

7. The method according to claim 6, wherein the application is provided by an application server.

8. The method according to claim 7 wherein the request or the response is a Hyper Text Transmission Protocol Message.

9. The method according to claim 6, wherein the application is provided by an application client.

10. The method according to claim 9 wherein the request or the response is a Session Initiation Protocol Message.

11. The method according to claim 1, wherein the trigger is contained in a header of a message.

12. The method according to claim 6, wherein the response includes an authorization of the request.

13. The method according to claim 12 wherein the application provides the authentication.

14. A network element for enabling charging access to a mobile application, the element comprising:
one or more I/O ports for receiving and transmitting messages; and
a processor communicatively coupled to the one or more I/O ports, the processor configured to:
identify a trigger received in a message, said trigger associated with a chargeable event;
identify a user requesting such an event; and
providing details of the chargeable event and the user to a charging function.

15. The network element according to claim 14, wherein the processor is further configured to identify an event identifier and a user identifier, said identifiers forming the details of the chargeable event.

16. The network element according to claim 15 wherein the event identifier is a Unified Resource Locator.

17. The network element according to claim 15, wherein the user identifier is a Mobile Subscriber Integrated Services Digital Network number.

18. The network element according claim 14, wherein the trigger comprises a request from a user terminal to an application.

19. The network element according to claim 14, wherein the trigger comprises a response from an application to a request from a user terminal.

20. The network element according to claim 19, wherein the application is provided by an application server.

21. The network element according to claim 20, in which the request or the response is a HTTP Message.

22. The network element according to claim 19, in which the application is provided by an application client.

23. The network element according to claim 22 wherein the request or the response is a SIP Message.

24. The network element according to claim 14, wherein the network element comprises a traffic analyzer.

25. The network element according to claim 14, wherein the trigger is present in a header of the received message.

26. The network element according to claim 14, wherein the network element comprises a Gateway General Packet Radio Service Support Node.

27. The mobile communications system including a network element according to claim 14.

28. A method of charging for a mobile application, the method comprising:
generating a trigger identifying a chargeable event and a user associated with a request for such an event; and
providing details of the chargeable event and the user to a charging function.

29. The method according to claim 28 wherein the step of providing details to the charging function comprises transmitting the trigger to a mobile communications network.

30. The method according to claim 28, wherein the trigger is generated in response to use of the mobile application.

31. The method according to claim 30 wherein the mobile application is a stand-alone application.

32. The method according to claim 28, wherein the trigger is a request to an application server.

33. The method according to claim 28, wherein the trigger is a request to a mobile terminal.

34. The method according to claim 28, further comprising creating a message containing the trigger in a header thereof.

35. A computer program stored on a tangible medium, the computer program comprising code for:
generating a trigger identifying a chargeable event and a user associated with a request for such an event; and
providing details of the chargeable event and the user to a charging function.

36. A mobile application including the computer program of claim 35.

37. A mobile terminal adapted for charging of a mobile application, comprising means for generating a trigger identifying a chargeable event and a user associated with the request for such an event, and means for providing details of the chargeable event and the user to a charging function.

38. A mobile terminal according to claim 37, wherein the means for providing details to the charging function comprises means for transmitting said details to a mobile communications network incorporating a charging function.
